(19) United States
(12) Patent Application Publication
(10) Pub. No.: US 2008/0161503 A1
(43) Pub. Date: Jul. 3, 2008

(54) Composition Comprising Ethylene Copolymer and Polyamide

(75) Inventors: Richard T. Chou, Hockessin, DE (US); Karlheinz Hausmann, Auvernier (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 11/965,510

(22) Filed: Dec. 27, 2007

Related U.S. Application Data
(60) Provisional application No. 60/877,913, filed on Dec. 29, 2006.

(51) Int. Cl. C08G 63/00

(52) U.S. Cl. 525/386; 525/55

(57) ABSTRACT

A composition and an article therewith are disclosed wherein the composition comprises or is a blend that comprises, consists essentially of, consists of, or is produced from, about 1 to about 40, or about 5 to about 35, about 10 to about 30, or about 10 to about 20 or 25% of a polyamide and about 60 to about 99, about 65 to about 95, about 70 to about 90, or about 75 or 80 to about 90% of an ionomer, all based on the weight of the blend.

This application claims priority to US provisional application Ser. No. 60/877913, filed Dec. 29, 2006, the entire disclosure of which is incorporated herein by reference.

The invention relates to a composition comprising ethylene copolymer and polyamide and to a product therewith.

### BACKGROUND

Polymer films are being used more frequently for surface decoration and protection instead of coatings. For example, polymer film decorations increasingly provide freedom of design, lower cost and are environmentally more compatible than the conventional coating process. The surfaces of many sports and industrial articles are designed with protective and decorative films. Many applications demand new materials available at an affordable cost for broad applications and with desired processability, mechanical properties, impact toughness, scratch resistance, and optical properties.

Ionomers are thermoplastic resins that contain metal ions in addition to organic-chain molecules, have solid-state properties characteristic of cross-linked polymers and melt-fabricability properties characteristic of uncrosslinked thermoplastic polymers, and are used in packaging and for sporting goods (e.g., golf balls). See e.g., U.S. Pat. No. 3,262,272). Commercially available ionomers including Surlyn®, available from E. I. du Pont de Nemours and Company, Wilmington, Del. (DuPont), are neutralized with a single metal ion (e.g., zinc or sodium).

Because they have water-like clarity and high toughness, ionomers have also been disclosed for use in protective and decorative applications, such as a top layer for floor tile (see e.g., WO 95/11333, disclosing the use of ionomers as the topcoat layer of a multilayer flooring material), with polyethylene. Most ionomers have a melting temperature below 100° C., lower than the melting temperature of low-density polyethylene of 120° C. Therefore, ionomers are vulnerable to scuffing thereby limiting the use of ionomers in more demanding applications.

Scuff resistance denotes resistance to the creation of a permanent surface mark through the frictional heating generated by a moving object sliding over the surface of the protective surface. Scuff resistance is a very desirable property when used in protective and decorative applications.

One way to solve the problems of scratching or scuffing a surface is to crosslink the ionomers by external crosslinking agents such as organic compounds or epoxy and formaldehyde functionalities. See, e.g., U.S. Pat. Nos. 3,264,269 and 3,317,631. Other solutions include increase in melting temperature by different synthesis conditions (e.g., U.S. Pat. No. 4,248,990).

These solutions are limited in effectiveness by the inherent melting temperature of polyethylene or add significant cost or feasibility problems to the processor and/or end user of the ionomer sheets and films used for protective applications.

Films made from polyamide, such as nylon-6, cannot be used for decorative and protective film applications, unless its toughness is improved, stiffness is reduced, and optical transparency is enhanced. Adding known modifiers may improve toughness and stiffness, but reduces the optical clarity thereby turning nylon into an opaque film. Blending polyamides with ionomers as disclosed in U.S. Pat. No. 3,317,631 may lead to blends with good scratch resistance and other surface properties but with very poor optical properties (i.e., opacity). Blends of this type consist of microscopic particles of one polymer dispersed in a continuous phase of the other polymer. Poorly dispersed and/or large particles tend to scatter rather than transmit light making the film made therefrom opaque.

New ionomers disclosed in U.S. Pat. No. 5,700,890 comprise repeat units derived from dicarboxylic acids or derivatives thereof and traditional monocarboxylic acids. These ionomers are highly compatible with polyamides than conventional ionomers (see e.g., U.S. Pat. No. 5,859,137), and renders superior mechanical properties for the modified polyamides. However, this patent does not disclose a method in addressing the poor scuff resistance of ionomers.

Therefore, there is a need to derive a new ionomer composition that can provide the required scuff resistance, while retaining toughness, and optical transparency, those merits inherent with ionomers. One way to solve the problem is to improve the dispersion of the two polymers within each other and narrow the particle size distribution of the blend.

### SUMMARY OF THE INVENTION

A composition comprises or is a blend that comprises, or is produced from, about 60 to about 99% of an ionomer and about 1 to about 40% of polyamide, by weight of the blend wherein the ionomer comprises repeat units derived from ethylene and one or more dicarboxylic acids; the carboxylic acids of a fraction thereof are neutralized with a metal ion.

Also provided is an article comprising or produced from the composition.

### DETAILED DESCRIPTION OF THE INVENTION

A thermoplastic composition for producing a film or sheet or molded articles of scuff- and scratch-resistant transparent material such as protective transparent coating or layer on scuff and scratch-exposed objects comprises or is a blend.

The blend may comprise, consist essentially of, consist of, or be produced from, about 5 to about 40, or about 5 to about 35, about 10 to about 30, or about 10 to about 20 or 25% of a polyamide and about 60 to about 95, about 65 to about 95, about 70 to about 90, or about 75 or 80 to about 90% of an ionomer, all based on the weight of the blend.

Any polyamides produced from lactams or amino acids, known to one skilled in the art, can be used. Polyamides from single reactants such as lactams or amino acids, referred as AB type polyamides are disclosed in Nylon Plastics (edited by Melvin L. Kohan, 1973, John Wiley and Sons, Inc.) and can include nylon-6, nylon-11, nylon 12, or combinations of two or more thereof. Polyamides prepared from more than one lactams or amino acids include nylon 6, 12.

Frequently used polyamides include nylon 6, nylon 7, nylon 8, nylon 11, nylon 12, nylon 6, 12, or combinations of two or more thereof especially nylon 6, nylon 11, nylon 12, or combinations of two or more thereof. Because polyamide and process therefor are well known to one skilled in the art, the disclosure of which is omitted herein for the interest of brevity.

Well known polyamides prepared from condensation of diamines and diacids, referred to as AABB type polyamides, may not be as good or suitable as the AB type for decorative film applications including nylon 66, nylon 610, nylon 612, and nylon 1212 as well as from a combination of diamines and diacids such as nylon 66/610. Similarly, non-aliphatic polyamides including poly(m-xylene adipamide) (such as nylon MXD6 from Mitsubishi Gas Chemical America Inc.) or amorphous polyamide produced from hexamethylene diamine and isophthalic/terephthalic acids may not be as suitable as the AB type) such as Selar® PA from DuPont. Polyamides based on a mixture of nylon 66, 6 may be useful if the presence of nylon 66 is less than 40 wt %.

The ionomer can comprise repeat units derived from ethylene, about 5 to about 15% of an α,β-unsaturated C₃-C₈ carboxylic acid, about 0.5 to about 12 or 4 to 10% of at least one unsaturated dicarboxylic acid or derivative thereof, and 0 to about 30% or 4 to 8% of a comonomer, all based on the weight of the ethylene copolymer. The unsaturated dicarboxylic acid or derivative thereof can be maleic acid, fumaric acid, itaconic acid, maleic anhydride, fumaric anhydride, itaconic anhydride, a C₁₋₄ alkyl half ester of one or more of these acids such as maleic acid monoester (e.g., ethyl hydrogen maleate, methyl hydrogen maleate, propyl hydrogen maleate, butyl hydrogen maleate, ethyl hydrogen fumarate, ethyl hydrogen itaconate, or combinations of two or more thereof), or combinations of two or more thereof.

The comonomer can be one or more alkyl (meth)acrylates having 1 to 12 or 1 to 8 carbons in the alkyl group.

The carboxylic acid functionalities in the ethylene copolymer are at least partially, from about 10 to about 70%, about 35 to about 70%, neutralized by one or more alkali metal ions, transition metal, alkaline earth metal ions, or combinations of two or more thereof such as Zn, P, Na, Li, Mg, Ca, Ba, Pb, Sn, Al, or combinations of two or more thereof such as Na/Zn. Methods for preparing ionomers from copolymers are well known in the art.

Wishing not to be bound by theory, the presence of dicarboxylic acid moieties in the ionomers enhances the compatibility with polyamides and provides blends with good transparency thereby providing the desired optical clarity, and surprisingly the scuff-resistance.

Comonomers such as alkyl(meth)acrylates can include alkyl acrylate and alkyl methacrylate such as methyl acrylate, ethyl acrylate and n-butyl acrylate. The alkyl(meth)acrylates can be present in amounts from 0 to about 15 or 30 weight %.

Examples of copolymers include copolymers of ethylene, methacrylic acid, and ethyl hydrogen maleate (E/MAA/MAME), of ethylene, acrylic acid and maleic anhydride (E/AA/MAH), or combinations thereof.

The composition or blend can optionally comprise additional thermoplastic materials blended with polyamide and ionomer to possibly allows one to more easily modify the properties of the composition by manipulating the amount and type of additional components present in the composition in addition to varying the percentages of the monomers in the ethylene acid copolymer; or to allow for easier, lower cost manufacture of the composition by allowing one to prepare fewer base resins that can be subsequently modified to obtain desired properties. Examples of other thermoplastic materials that can be used include non-ionomers and/or ionomers.

The composition or blend can further include one or more E/X/Y copolymers where E is ethylene, X is a C₃₋₈ α,β-ethylenically unsaturated carboxylic acid, and Y is one or more alkyl(meth)acrylates as disclosed above. X is present in from about 2 to about 30% and Y is present from 0 to about 40%, based on the weight of the E/X/Y copolymer, where the carboxylic acids can be at least partially neutralized by one or more metal ions as disclosed above. Non-limiting, illustrative examples of E/X/Y copolymers (including acid copolymer, ionomer of the acid copolymer, or combinations thereof) include E/15MAA/Na, E/19MAA/Na, E/15AA/Na, E/19AA/Na, E/15MAA/Mg and E/19MAA/Li (wherein E represents ethylene, MAA represents methacrylic acid, AA represents acrylic acid, the number represents the weight % of monocarboxylic acid present in the copolymer and the atomic symbol represents the neutralizing cation). When such E/X/Y copolymers are added, the E/X/Y copolymers can substitute for up to half (50% by weight) of the ionomer comprising repeat units derived from dicarboxylic acid(s).

Non-ionomers can include copolyetheramides, elastomer polyolefins, styrene diene block copolymers (e.g., styrene-butadiene-styrene (SBS)), thermoplastic elastomers, thermoplastic polyurethanes (e.g., polyurethane), polyetherester, polyamideether, polyether-urea, PEBAX (a family of block copolymers based on polyether-block-amide, commercially supplied by Atochem), styrene(ethylene-butylene)-styrene block copolymers, etc., polyamide(oligomeric and polymeric), polyesters, polyolefins (e.g., polyethylene, polypropylene, or ethylene/propylene copolymers), ethylene copolymers (with one or more comonomers including vinyl acetate, (meth)acrylates, (meth)acrylic acid, epoxy-functionalized monomer, CO, etc., functionalized polymers with maleic anhydride, or epoxidization), grafting, elastomers such as EPDM, metallocene catalyzed PE and copolymer, ground up powders of the thermoset elastomers, or combinations of two or more thereof.

The composition or blend can comprise 0.0001 to about 10%, based on the weight of the composition or blend, of optional additives including plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, or combinations of two or more thereof.

The blend may be produced by any means known to one skilled in the art, e.g., dry blending/mixing, extruding, co-extrusion, to produce the composition. The composition can be formed into articles by various means known to those skilled in the art. For example, the composition can be molded or extruded to provide an article that is in a desired shape; be cut, injection molded, overmolded, laminated, extruded, milled or the like to provide a desired shape and size; or be cast or blown into a sheet or film. The film or sheet includes multilayer film or sheet that can be used as, for example, a transparent protective scratch-resistant film or sheet on an article.

Articles comprising a conductive thermoplastic composition also may be further processed. For example, portions of the composition (such as, but not limited to, pellets, slugs, rods, ropes, sheets and molded or extruded articles) may be subjected to thermoforming operations in which the composition is subjected to heat, pressure and/or other mechanical forces to produce shaped articles. Compression molding is an example of further processing.

A multilayer film made from the composition and, optionally, other polymer layer(s) may be formed independently and then adhesively attached to one another to form an article. For example, additional layers can comprise or be produced from thermoplastic resins to provide structure layers, to provide protection or improve the appearance of the article, to which the layer made from the composition is adhered. Examples include multilayer films comprising ionomers or non-ionomers disclosed above as at least one additional layer.

A multilayer film could be further processed by thermoforming into a shaped article. For example, a sheet of the multilayer structure could be formed into a casing element for a portable communication device or it could be formed into a shaped piece that could be included in an automotive part such as a bumper, fender or panel.

An article may also be fabricated by extrusion coating or laminating some or all of the layers onto a substrate. Examples of articles include an article comprising the composition transformed into a transparent protective scratch-resistant film or sheet or outside (top) layer on a scratch-exposed object such as a transparent scratch-resistant layer on auto interior or exterior applications, for flooring tiles or sheets, for a sporting good, or as packaging film for dry abrasive goods.

A laminate film can be prepared by coextrusion. For example, granulates of the composition or components thereof are melted in extruders to produce molten polymers, which are passed through a die or set of dies to form layers of molten polymers that are processed as a laminar flow. The molten polymers are cooled to form a layered structure. Molten extruded polymers can be converted into a film using any techniques known to one skilled in the art. For example, a film of the present invention can also be made by coextrusion followed by lamination onto one or more other layers. Other converting techniques are, for example, blown film extrusion, cast film extrusion, cast sheet extrusion and extrusion coating.

A film can be further oriented beyond the immediate quenching or casting of the film. The process comprises the steps of (co)extruding a laminar flow of molten polymers, quenching the (co)extrudate and orienting the quenched (co)extrudate in at least one direction. The film may be uniaxially oriented, or it can be biaxially oriented by drawing in two mutually perpendicular directions in the plane of the film to achieve a satisfactory combination of mechanical and physical properties.

Orientation and stretching are well known to one skilled in the art and the description of which is omitted herein for the interest of brevity.

The film or sheet may be laminated to substrates including sheets or films of polymer materials including nonwoven materials or nonpolymer materials such as glass, paper, or metal foil. For example, sheet or film can be adhered to substrates to provide flooring tiles or sheets by coextrusion, extrusion coating or any lamination techniques.

Sheets or films can be adhered to shaped substrates to provide a protective layer or be thermoformed by heat and/or pressure to adhere to a substrate to form an automotive part or a sporting good.

The composition can also be adhered to shaped substrates by injection molding or compression molding.

### EXAMPLES

The following Examples are merely illustrative, and are not to be construed as limiting the scope of the invention.

### Description of Processing and Testing of Materials:

Table 1 shows the properties of blends of polyamide and ionomer containing dicarboxylic acids (i.e., anhydride Surlyn®). Table 2 compares the properties of blends of different polyamide and anhydride Surlyn® and the resulting cast films. Table 3 shows the properties of cast films of a blend of anhydride Surlyn®, a conventional Surlyn® and nylon 6 and a conventional Surlyn®. The blends were prepared by melt mixing the base resins in a 30-mm twin-screw extruder. The cast films were prepared using a slot die cast film line with a 28-mm diameter, 28:1 length to diameter ratio (L/D) twin screw extruder operating with ramped extruder zone temperatures of 210° C. to 250° C.

The polymers used were as follows.
Nylon 6: Ultramid B3 (from BASF) with a melting point of 225° C.
Nylon 11: Rilsan BESNO TL (from Arkema Inc.) with a melting point of 189° C.
Nylon 12: Rilsan AESNO TL (from Arkema Inc) with a melting point of 180° C.
Nylon 612: Zytel® 158 (from DuPont; a polyamide from hexamethylene diamine and dodecanedioic acid with a melting point of 218° C.)
Nylon 6, 12: Grilon CR-9 (from EMS-GRIVORY; a polyamide from caprolactam and dodecanolactam with a melting point of 200° C.).
Anhydride Surlyn® A: a terpolymer comprising ethylene, 11 weight % of methacrylic acid, and 6 weight % of maleic anhydride monoethylester; nominally 40% of the available carboxylic acid moieties were neutralized with zinc cations
(E/11MAA/6MAME/40Zn); having a melt temperature of 98° C.
Anhydride Surlyn® B: a terpolymer comprising ethylene, 11 weight % of methacrylic acid and 6 weight % of maleic anhydride monoethylester; nominally 60% of the available carboxylic acid moieties were neutralized with zinc cations (E/11MAA/6MAME/60Zn).
Surlyn® 1706: a Zn ionomer from DuPont.

The resulting blends were extruded to form either injection-molded plaques or films as described further below.

The Izod impact was measured using ASTM D-256 with an injection-molded specimen. The tensile strength was measured using ASTM D-638 with press-molded films about 10-15 mil thick. The transmittance haze was measured according to ASTM D1003 using press-molded films about 10-15 mil thick.

Sheet of the blends were prepared on a laboratory 2-roll mill and pressing the so-obtained sheet in a hydraulic press into plaques of the dimensions 100 mm×100 mm×3 mm. These plaques were tested immediately and after one month for scratch resistance using a scratch tester by Eirichsen according to ISO1518 where a mass between 0.1 and 2 kg was applied to a needle that was drawn over the surface of the plaque. This apparatus measured the force in Newtons at which a scratch mark was visible on the surface.

A scuff test was also performed. This type of test was not standardized; different versions were used by those skilled in the art of scuff testing. Usually the severity of a scuff mark was related to the ease of melting of the polymer under the influence of frictional heat. Scuff tests consisted of subjecting the sample surface to the high-speed friction of a moving object, which was the Taber abrader wheel CSO according to ASTM D3389. The wheel was moved over the sample surface using a pendulum with a pendulum radius of 86 cm and a mass of 2.96 kg. The Taber abrader wheel was fixed in a way that the axis of the wheel created an angle of 45 degrees to the scuffed surface. The scuffed or to be scuffed surface of the sample was positioned at an angel of 5 degrees to the floor/ground surface to decelerate the movement of the pendulum. The resulting scuff marks were judged on a scale of 1 to 5 (1 being minor and 5 being severe). For purposes of this scuff measurement a commercial grade Surlyn® (E/15%MAA-Zn) was assigned the rating “5” (i.e., failed) and a comparative rating of between 2 and 3 or lower was considered passing.

Taber abrasion was performed according to Abrasion Taber tester ISO 5470 Method B reporting weight loss after 1000 turns.

Scratch resistance was performed according to according ISO 1518. The weight used to create the scratches was from 1-20N. The number in Table 3 indicates the minimum weight necessary to create a visible, permanent scratch.

Comparative Examples C-1 and C-2 (i.e., blends of nylon 6 with low amounts of anhydride Surlyn®) exhibited low impact strength and poor optical properties (as indicated by the haze values reported in Table 1). Table 1 demonstrates that the blends comprising nylon 6 and high amounts of anhydride Surlyn® had high toughness, good mechanical strength, and good optical properties. It was unexpected that the blends exhibited excellent scuff resistance.

TABLE 1
Properties of Blends of Nylon 6 and Anhydride Surlyn ®

| | | | | Notched Izod Impact | | Tensile Properties | | |
|---|---|---|---|---|---|---|---|---|
| | Anhydride | Haze | | Room Temperature | 0° C. | Strength | Elongation | |
| | Surlyn ® (Wt %) | (%) | Scuff Test | (ft-lbs) | (ft-lbs) | (kpsi) | (%) | |
| C-1 | A (20) | 68 | N/A | 2.4 | 1.7 | 6.2 | 280 | 115 |
| C-2 | A (30) | 65 | N/A | 3.6 | 2.3 | 4.9 | 150 | 105 |
| 1 | A (40) | 20 | passed | 25.8 | 21 | 4.3 | 300 | 80 |
| 2 | A (45) | 8.8 | passed | 23 | 25 | 4.2 | 250 | 65 |
| 3 | A (50) | 7.2 | passed | 22.2 | 26 | 3.6 | 250 | 57 |
| 4 | A (55) | 6.5 | passed | 21 | 25 | 3.4 | 260 | 48 |
| 5 | A (60) | 6.0 | passed | 21 | 24 | 3.8 | 340 | 45 |
| 6 | B (45) | 30 | | 27 | 27 | 5.8 | 380 | 80 |

Table 2 demonstrates that only aliphatic AB-type polyamides, i.e., from lactams or amino acids, were suitable for making decorative films according to this invention. Examples 7, 8, 9 and 10 were blends of aliphatic AB type nylon with anhydride Surlyn® at a composition ratio of 60/40 wt %. The blends exhibited superior toughness (Izod Impact) down to −20° C. The injection molded specimens were used for Izod impact test. Cast films about 3-4 mils of high transparency were obtained from the blends Examples. Comparative Example 3, a blend of nylon 612, an aliphatic AABB type polyamide, and anhydride Surlyn®, also exhibited good impact toughness. However, a cast film of good quality could not be made in good quality, and the film was torn and opaque.

Similar observations were found for the blends of nylon 66 and anhydride Surlyn® (B), and for the blends of Selar® PA 3426 (amorphous polyamide from DuPont) and anhydride Surlyn® (B). Both blends failed to produce good optical clear cast film. The nylon 66 used was Zytel® 101 from DuPont and Selar® PA 3426 was an amorphous polyamide derived from hexamethylene diamine and isophthalic/terephthalic acids.

TABLE 2*

| | | | | Notched Izod Impact | | |
|---|---|---|---|---|---|---|
| Example | Polyamide (wt %) | Surlyn ® (wt %) | Cast film (%) | RT (° C.) | 0° C. | −20° C. |
| C-3 | nylon 612 (60) | B (40) | failed to produce | 23.8 | 22.87 | 15 |
| 7 | nylon 6 (60) | B (40) | transparent film | 27 | 26 | 10.2 |
| 8 | nylon 12 (60) | B (40) | transparent film | 22.1 | 20.8 | 18.9 |
| 9 | nylon 11 (60) | B (40) | transparent film | 22.9 | 21.9 | 22.4 |
| 10 | nylon 6, 12 (60) | B (40) | transparent film | 27.7 | 27.1 | 29.78 |

*RT = Room temperature, about 23° C.

Table 3 demonstrates unexpected discovery that with only the presence of a 10% of nylon 6 in the composition led to excellent films with superior scuff resistance and abrasion resistance and scratch film. The cast film had high optical clarity. Despite the excellent scratch resistance and abrasion resistance, Comparative Example 4, which was a conventional Surlyn® 1706 often used for floor tile applications comprising no repeat units derived from a dicarboxylic acid, failed to pass the scuff test. In fact, not shown here, none of Surlyn® that did not comprise repeat units derived from a dicarboxylic acid passed the scuff-resistant test.

TABLE 3

| | | Form Cast | | | Taber |
|---|---|---|---|---|---|
| Example | Composition* | Film | Scuff Test | Scratch (N) | abrasion (g) |
| Ex 11 | Surlyn AD 1032/ | 600 μm | Passed | 10 | 0.0015 |
| | Surlyn 1706/Nylon 6 | | | | |
| C-4 | Surlyn ® 1706 | 300 μm | Failed | 6 | 0.0023 |
| | ZC02-29-R1 | | | | |

*The weight ratio of Surlyn ® AD 1032/Surlyn ® 1706/Nylon 6 was 60/30/10 (by weight) and the composition of Surlyn ® 1706 ZC02-29-R1 was a Zn ionomer of ethylene and 15 wt % methacrylic acid.

Table 4 shows unexpected results of superior scuff resistance of the blends containing only 10 and 20 wt % of nylon 6. Example 12 was a blend of anhydride Surlyn® B, (45 wt %), Surlyn® 1706 (35 wt %), and nylon 6 (20 wt %) with added stearamide (at 0.75 wt % of the polymer blend).

Example 13 was a blend of anhydride Surlyn® B (55 wt %), Surlyn® 1706 (35 wt %), and nylon 6 (10 wt %) with added stearamide (at 0.75 wt % of the polymer blend).

Comparative Example C-5 was Surlyn® 1706.

Coextruded bi-layer films were made from the blends Example 12 and Example 13 for conducting scuff-resistance and abrasion resistant test. The films of Example 12 and Example 13 exhibited both scuff resistant and abrasion resistance. Film made from comparative example C-5, though showing abrasion resistance failed in scuff-resistant test. Poor means: A visible remaining scuff mark is obtained that cannot be removed anymore without abrading the surface of the floor tile mechanically. Acceptable means that the scuff mark is less visible and can be removed by rubbing with a cotton cloth

TABLE 4

| | External layer/Internal | Taber 1000 turns | Scuff |
|---|---|---|---|
| | layer (cast film) | (g) | resistance |
| Example 12 | Bi-layer film: Example | 0.0035 | Acceptable |
| | 7/Surlyn ® 1706 | | |
| Example 13 | Bi-layer film: Example | 0.0031 | Acceptable |
| | 7/Surlyn ® 1706 | | |
| Com Ex C-5 | Monolayer film: | 0.0024 | Poor |
| | Surlyn ® 1706 | | |

1. A composition comprising a blend wherein
the blend comprises or is produced from about 5 to about 40% of a polyamide and about 60 to about 95% of an ionomer, all based on the weight of the blend;
the ionomer comprises repeat units derived from ethylene, a dicarboxylic acid or derivative thereof, a monocarboxylic acid, and optionally a comonomer;
the monocarboxylic acid includes (meth)acrylic acid; and
the dicarboxylic acid includes maleic acid, fumaric acid, itaconic acid, maleic anhydride, fumaric anhydride, itaconic anhydride, one or more C₁₋₄ alkyl half ester of maleic acid, one or more C₁₋₄ alkyl half ester of fumaric acid, one or more C₁₋₄ alkyl half ester of itaconic acid, or combinations of two or more thereof.

2. The composition of claim 1 wherein the blend comprises or is produced from, about 5 to about 35% of the polyamide and about 65 to about 95% of the ionomer.

3. The composition of claim 2 wherein the blend comprises or is produced from, about 10 to about 30% of the polyamide and about 70 to about 90% of the ionomer; the blend further comprises the comonomer including one or more alkyl(meth)acrylates; and the alkyl group of the alkyl(meth)acrylate has 1 to 12 carbon atoms per group.

4. The composition of claim 3 wherein the blend comprises or is produced from, about 10 to about 25% of the polyamide and about 75 to about 90% of the ionomer, all based on the weight of the blend.

5. The composition of claim 2 wherein the composition is the blend.

6. The composition of claim 2 wherein the polyamide comprises no polyamide derived from condensation of one or more diamines and one or more diacids.

7. The article of claim 3 wherein the dicarboxylic acid or derivative include one or more C₁₋₄ alkyl half ester of maleic acid.

8. The composition of claim 7 wherein the composition is the blend and the polyamide is nylon 6.

9. The article of claim 4 wherein the dicarboxylic acid or derivative include one or more C₁₋₄ alkyl half ester of maleic acid.

10. An article comprising or produced from a composition wherein the composition is as recited in claim 1.

11. The article of claim 10 wherein the article is a film or sheet.

12. The article of claim 11 wherein the blend comprises or is produced from, about 5 to about 35% or about 10 to about 30% of the polyamide and about 65 to about 95% or about 70 to about 90% of the ionomer; and the film or sheet is a protective or decorative layer of flooring tile, sporting good, or part of a vehicle.

13. The article of claim 12 wherein the blend comprises or is produced from, about 10 to about 25% of the polyamide and about 75 to about 90% of the ionomer; the blend further comprises the comonomer including one or more alkyl(meth)acrylates; and the alkyl group of the alkyl(meth)acrylate has 1 to 12 carbon atoms per group.

14. The article of claim 12 wherein the polyamide comprises no polyamide derived from condensation of one or more diamines and one or more diacids.

15. The article of claim 13 wherein the dicarboxylic acid or derivative include one or more C₁₋₄ alkyl half ester of maleic acid and the polyamide includes nylon 6, nylon 11, nylon 12, nylon 6, 12, or combinations of two or more thereof.

16. The article of claim 12 wherein the article comprises coextruded layers wherein one of the layers comprises or is derived from the composition.

17. The article of claim 16 wherein the polyamide comprises no polyamide derived from condensation of diamines and one or more diacids.

18. The article of claim 16 wherein the dicarboxylic acid or derivative include one or more C₁₋₄ alkyl half ester of maleic acid; one or more of the layers comprises one or more pigments, dyes, flakes, or combinations of two more thereof.

19. The article of claim 18 the layers further comprises one or more layers including ionomer, ionomer-polyethylene blend, ionomer-polyamide blend, very low density polyethylene, ethylene polar copolymer, or combinations of two or more thereof.

20. The article of claim 12 wherein the polyamide is nylon 6.
